(19) United States
(12) Patent Application Publication
(10) Pub. No.: US 2003/0218323 A1
(43) Pub. Date: Nov. 27, 2003

(54) Gas bag module

(75) Inventor: Werner Berbalk, Vordersteinenberg (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Occupant Restraint Systems GmbH & Co. KG

(21) Appl. No.: 10/392,982

(22) Filed: Mar. 20, 2003

(30) Foreign Application Priority Data
May 21, 2002 (DE) 202 07 860.4

(51) Int. Cl. B60R 21/16

(52) U.S. Cl. 280/743.1

(57) ABSTRACT

A gas bag module includes folded gas bag (10). The gas bag (10) is surrounded by a cover (12). The cover (12) is placed into several folds in some areas. The folds are connected with each other by a seam (22). The seam (22) is torn open by the expansion pressure of the unfolding gas bag (10).

### TECHNICAL FIELD

The invention relates to a gas bag module.

### BACKGROUND OF THE INVENTION

Such a gas bag module is arranged in the vehicle behind a covering, which is able to swing open, under the instrument panel. On activation of the gas bag, there must be no danger to the occupants from the covering as it detaches itself from the instrument panel. From the DE-U-297 11 679 a gas bag module is known, by which a reduction to the striking speed of the covering onto an obstacle can be achieved. The cover provided in this module permits the unfolding of the gas bag initially up to a particular volume in a main direction pointing out from the module into the interior of the vehicle. Through the expansion pressure of the unfolding gas bag, the cover is made taut, so that the gas bag then expands laterally to the main direction, until the cover finally tears open on a tear line and only then frees the further expansion of the gas bag in the main direction.

### BRIEF SUMMARY OF THE INVENTION

The invention provides a gas bag module by which the unfolding of the gas bag can be even better controlled and hence the opening behaviour of the covering can be controlled even better. According to the invention, the gas bag module comprises a folded gas bag. The gas bag is surrounded by a covering which is placed into several folds in some areas. The folds are connected with each other by a seam which is torn open through the expansion pressure of the unfolding gas bag. By an adequate design of the tear seam, the expansion behaviour can be influenced in line with specific objectives at the start of the unfolding phase, so that too hard a striking of the torn-open covering, for example onto the front windscreen, can be avoided. In addition, the cover serves as a protective covering for the gas bag, for protection from external environmental influences.

According to a preferred embodiment, the cover has in addition a tear line, along which the cover is torn open by the expansion pressure of the unfolding gas bag. The tear line in this case is preferably constructed so that the cover is only torn open after the tearing open of the seam connecting the folds, along the tear line. Hence, it is ensured that the gas bag firstly unfolds in the main direction, then to the sides and only in the main direction again after the tearing open of the cover.

### BRIEF DESCRIPTION OF THE DRAWINGS

FIG. 1 shows a diagrammatic lateral sectional view of a gas bag surrounded by a cover;

FIG. 2 shows a top view of a cover in the state when spread out flat;

FIG. 3 shows a perspective view of a module housing with a gas generator; and

FIG. 4 shows a perspective side view of a gas bag module.

### DETAILED DESCRIPTION OF THE PREFERRED EMBODIMENT

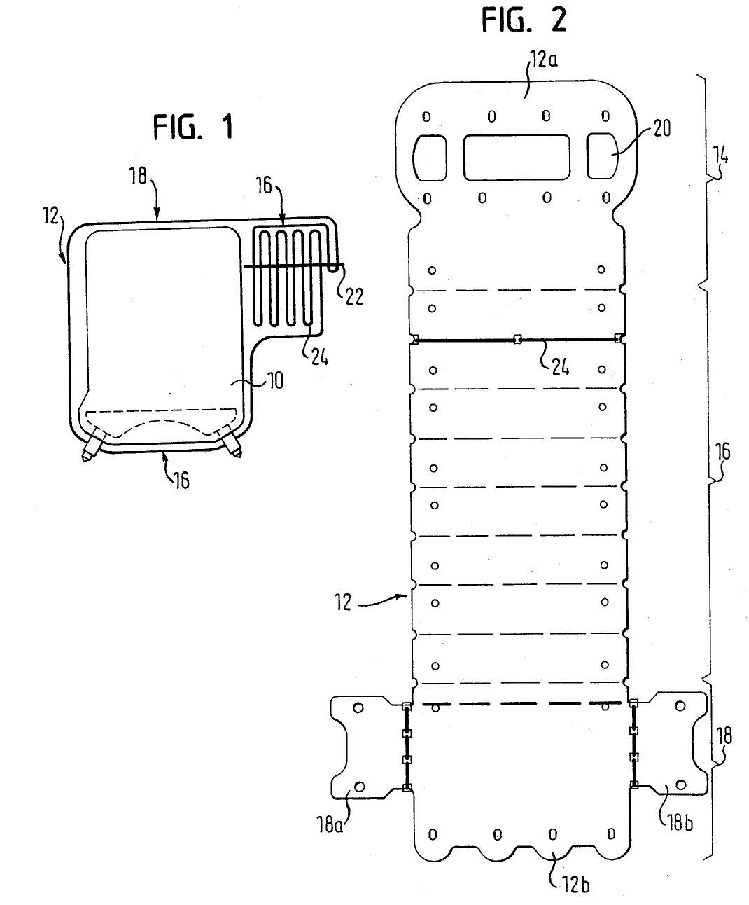

The gas bag 10 illustrated in FIG. 1 is in the folded state and is surrounded by a cover 12. The cover 12 shown in the state when spread out flat in FIG. 2 is band-shaped and has two ends 12a, 12b, with which it is fastened in the gas bag module, as is explained in further detail later. The cover 12 has a first section 14 in which several openings 20 are provided. The cover 12 is placed around the gas bag 10 so that the openings 20 lie opposing the inflation opening of the gas bag 10. A second section 16 of the cover 12 is folded in a zig-zag manner and lies flat on the folded gas bag 10. The folds of the second section are connected with each other by a seam 22. One of the fold edges is constructed as a tear line 24 which extends over the entire width of the cover 12. A third section 18 of the cover 12 has two laterally arranged tongues 18a, 18b which embrace the end faces of the folded gas bag 10.

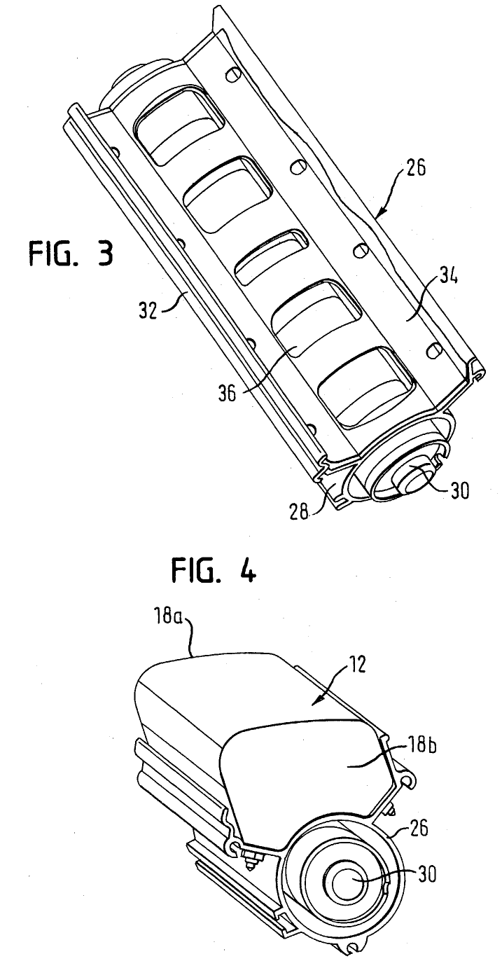

FIG. 3 shows a module housing 26 with a first mounting 28, into which a gas generator 30 is inserted. A second mounting 32 is provided for the gas bag package consisting of gas bag 10 and cover 12. The second mounting 32 comprises a holding plate 34 on which the two ends 12a, 12b of the cover 12 are secured. The housing 26 has, in addition, openings 36 through which the gas emerging from the outflow openings of the gas generator 30 can enter into the gas bag 12.

FIG. 4 shows a gas bag module with housing 26, gas generator 30 and gas bag package. The gas bag package is arranged in the second mounting 32 so that the first section 14 of the cover 12 with the openings 20 lies opposing the openings 36 of the housing 26, and the second section 16 of the cover 12 with the folds in the installed state of the module under the instrument panel lies opposing the covering.

On activation the gas bag 10 is inflated by the gas generator 30. The tear seam 22, by which the folds of the gas bag 10 are connected with each other, is constructed so that it tears open at a particular internal pressure of the gas bag 10 at the start of the unfolding process, whereby the cover 12, however, is not destroyed. Rather, the release of the folds permits an expansion of the gas bag 10 in a main direction pointing from the module into the interior of the vehicle until the gas bag 10 has reached a volume at which the surrounding cover 12 is made taut and offers a stronger resistance to further expansion in this direction. In this phase, i.e. after the tearing open of the seam 22, the covering, behind which the gas bag module is arranged, is opened by the unfolding gas bag 10. In the phase following on therefrom, the gas bag 10 expands to the sides before the cover 12 tears open along the tear line 24 through the further rising expansion pressure, and the gas bag 10 can spread out again in the main direction. At this moment, the covering is, however, already opened so far that it does not undergo any further substantial acceleration through the gas bag 10 expanding further.

1. A gas bag module, comprising a folded gas bag (10), the gas bag (10) being surrounded by a cover (12) placed into several folds in some areas, said folds being connected with each other by a seam (22) which is torn open by an expansion pressure of said unfolding gas bag (10).

2. The gas bag module according to claim 1, wherein said cover (12) has in addition a tear line (24), along which said cover (12) is torn open by said expansion pressure of said unfolding gas bag (10).

3. The gas bag module according to claim 2, wherein said tear line (24) is constructed so that said cover (12) is torn open after tearing open of said seam (22) along said tear line (24).

4. The gas bag module according to claim 1, wherein a covering is provided which closes an outlet opening for said gas bag (10) and which can be opened by said unfolding gas bag (10).

5. The gas bag module according to claim 4, wherein said cover (12) is constructed so that said covering is opened after tearing open of said seam (22).

6. The gas bag module according to claim 1, further comprising a holding plate (34) for said gas bag (10), said cover (12), in a state when spread out flat, forming a band having ends (12a, 12b) which are secured on said holding plate (34).

7. The gas bag module according to claim 6, wherein said cover (12) surrounding said folded gas bag (10) also covers the sides of said gas bag (10).
